(19) United States
(12) Patent Application Publication
(10) Pub. No.: US 2006/0233519 A1
(43) Pub. Date: Oct. 19, 2006

(54) Content playback system, content playback apparatus, and content playback method

(75) Inventor: Tetsuya NARITA, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-Ku (JP)

(21) Appl. No.: 11/278,280

(22) Filed: Mar. 31, 2006

(30) Foreign Application Priority Data
Apr. 18, 2005 (JP) P2005-119706

(51) Int. Cl. H04N 7/00

(52) U.S. Cl. 386/95

(57) ABSTRACT

A content playback system includes a content server providing content, a plurality of content playback apparatuses playing back the content, and a portable terminal capable of communicating with each of the plurality of content playback apparatuses at least in accordance with a short-distance communication method. The content playback apparatuses each includes playback means for playing back the content, detecting means for detecting the portable terminal, transmitting means for transmitting to the portable terminal playback interruption information, and provision request means for receiving the playback interruption information and requesting the content server to provide the corresponding content. The portable terminal includes storing means for receiving and storing the playback interruption information from a first content playback apparatus, and playback request means for transmitting the playback interruption information to a second content playback apparatus and requesting the second content playback apparatus to play back the corresponding content.

### CROSS REFERENCES TO RELATED APPLICATIONS

The present invention contains subject matter related to Japanese Patent Application JP 2005-119706 filed in the Japanese Patent Office on Apr. 18, 2005, the entire contents of which are incorporated herein by reference.

### BACKGROUND OF THE INVENTION

1. Field of the Invention

The present invention relates to a content playback system including a plurality of content playback apparatuses, a content playback apparatus, and a content playback method in the content playback system, and more particularly, to a content playback system, a content playback apparatus, and a content playback method in which continuous playback of the same content can be performed between content playback apparatuses.

2. Description of the Related Art

Recently, in general, image signals and audio signals are handled as digital data. For example, playback apparatuses for music compact discs (CDs) and digital versatile discs (DVDs) on which video content is recorded are widely used in homes. In particular, instead of known recorders using videotapes, recorders capable of recording video content on DVDs or hard disk drives (HDDs) are becoming commonplace. In addition, playing back video and audio content using personal computers (PCs) and downloading such data via the Internet is becoming popular.

In addition, commonly, even in homes, a local-area network (LAN) system is established by connecting a PC to a peripheral apparatus, and files and a printer are shared between the PC and the peripheral apparatus. Recently, connecting the above-mentioned recording/playback apparatuses for video and audio content to a home network is considered. For example, a system in which video and audio content that is collectively stored on a relatively high-capacity storage device, such as an HDD, can be distributed via the network to playback apparatuses installed in different rooms is considered.

When such a distribution system for video and audio content via a home network is used, for example, a user who is viewing or listening to content using a player in a room may need to move to another room due to an unexpected visitor or the like. In such a case, the user stops a playback operation of the player that is installed in the room in which the user is staying and starts a player that is installed in the other room to which the user moves. In order to view or listen to the content from a position where the user stopped viewing or listening, the user needs to remember the name of the content and the final position where the user viewed or listened to so that such information can be set to the player by which the content is to be played back.

In such circumstances, a data transmission apparatus that is capable of continuous viewing or listening of content by causing a server that distributes the content to store content management information indicating playback interruption when a client terminal, that is, a player in each room interrupts playback and by causing another client terminal to resume playback of the content in accordance with the stored content management information is described, for example, in Japanese Unexamined Patent Application Publication No. 2004-102415 (paragraphs [0037] to [0049] and FIG. 2).

### SUMMARY OF THE INVENTION

However, even in a system including the data transmission apparatus disclosed in Japanese Unexamined Patent Application Publication No. 2004-102415, for example, when an input operation for a client terminal to interrupt playback of content is complicated, when an input operation for another client terminal to resume playback of the same content is complicated, or when an operation procedure or an operation key is different depending on the client terminal, a user feels confused, and the feature of continuous playback may not be used.

It is desirable to provide a content playback system in which playback of content that is played back by an apparatus can be continued by another apparatus with a simple user operation.

It is also desirable to provide a content playback apparatus in which playback of content that is played back by a content playback apparatus can be continued by another content playback apparatus with a simple user operation.

It is also desirable to provide a content playback method in which playback of content that is played back by an apparatus can be continued by another apparatus with a simple user operation.

A content playback system according to an embodiment of the present invention includes a content server that provides content, a plurality of content playback apparatuses that plays back the content provided from the content server, and a portable terminal that is capable of communicating with each of the plurality of content playback apparatuses at least in accordance with a short-distance communication method. Each of the plurality of content playback apparatuses includes playback means for playing back the content provided from the content server, detecting means for detecting the portable terminal in accordance with the short-distance communication method, transmitting means for transmitting to the portable terminal detected by the detecting means playback interruption information including content identification information for identifying the content when playback of the content by the playback means is interrupted, and provision request means for receiving the playback interruption information from the portable terminal detected by the detecting means and for requesting the content server to provide the corresponding content in accordance with the playback interruption information. The portable terminal includes storing means for receiving and storing the playback interruption information from a first content playback apparatus that detects the portable terminal by the detecting means, and playback request means for transmitting the playback interruption information stored in the storing means to a second content playback apparatus that detects the portable terminal by the detecting means after the portable terminal receives the playback interruption information and for requesting the second content playback apparatus to play back the corresponding content.

In such a content playback system, when, in a first content playback apparatus, playback of content by playback means is interrupted, detecting means of the first content playback apparatus detects a portable terminal in accordance with a short-distance communication method. Transmitting means transmits to the detected portable terminal playback interruption information including content identification information for identifying the content, and the playback interruption information is stored in storing means of the portable terminal.

Then, when detecting means of a second content playback apparatus detects the portable terminal, playback request means of the portable terminal transmits to the second content playback apparatus the playback interruption information stored in the storing means, and requests the second content playback apparatus to play back the corresponding content. Provision request means of the second content playback apparatus receives the playback interruption information from the portable terminal, and requests a content server to provide the corresponding content in accordance with the playback interruption information. Thus, the interrupted content is provided to the second content playback apparatus, and played back by playback means.

According to the above-described content playback system, a first content playback apparatus by which playback of content is interrupted transmits playback interruption information including content identification information on the interrupted content to a portable terminal detected in a short-distance communication method, and the portable terminal stores the playback interruption information. Then, when a second content playback apparatus detects the portable terminal, the playback interruption information stored in the portable terminal is transmitted to the second content playback apparatus. The second content playback apparatus that receives the playback interruption information requests, in accordance with the playback interruption information, a content server to provide the content whose playback is interrupted, and plays back the content. As described above, by causing each of the content playback apparatuses to detect the portable terminal in accordance with the short-distance communication method, a user does not need to perform a setting operation, for example, for selecting content to be played back. Thus, playback of the same content can be continued by the second content playback apparatus with a simple operation.

A content playback system according to another embodiment of the present invention includes a plurality of content playback apparatuses that plays back content, and a portable terminal that is capable of communicating with each of the plurality of content playback apparatuses at least in accordance with a short-distance communication method. Each of the plurality of content playback apparatuses includes playback means for playing back the content, detecting means for detecting the portable terminal in accordance with the short-distance communication method, storing means for receiving from the portable terminal detected by the detecting means terminal identification information for identifying the portable terminal and for storing, in association with the received terminal identification information, playback interruption information including content identification information for identifying content whose playback is interrupted when playback of the content by the playback means is interrupted, transmission request means for multicasting the terminal identification information to other content playback apparatuses and for requesting transmission of playback interruption information corresponding to the terminal identification information when the terminal identification information of the portable terminal and a playback request for the content are received from the portable terminal detected by the detecting means, playback interruption information transmitting means for reading the playback interruption information corresponding to the received terminal identification information from the storing means and for transmitting the read playback interruption information when a transmission request for the playback interruption information is received from another content playback apparatus, and playback control means for acquiring the corresponding content in accordance with the playback interruption information and for causing the playback means to play back the acquired content when the playback interruption information transmitted in response to the transmission request by the transmission request means is received. The portable terminal includes terminal identification information transmitting means for transmitting the terminal identification information of the portable terminal to a first content playback apparatus that detects the portable terminal by the detecting means, and playback request means for transmitting the terminal identification information of the portable terminal to a second content playback apparatus and for requesting the second content playback apparatus to play back the corresponding content when the portable terminal is detected by the detecting means of the second content playback apparatus after the terminal identification information transmitting means transmits the terminal identification information.

In such a content playback system, when playback of content by playback means in a first content playback apparatus is interrupted, detecting means of the first content playback apparatus detects a portable terminal in accordance with a short-distance communication method, and terminal identification information transmitting means of the portable terminal transmits to the first content playback apparatus terminal identification information of the portable terminal. Storing means of the first content playback apparatus receives the terminal identification information from the portable terminal, and stores, in association with the received terminal identification information, playback interruption information including content identification information for identifying the content whose playback is interrupted.

Then, when detecting means of a second content playback apparatus detects the portable terminal, playback request means of the portable terminal transmits to the second content playback apparatus the terminal identification information of the portable terminal and requests the second content playback apparatus to play back the corresponding content. Transmission request means of the second content playback apparatus that receives the playback request multicasts the received terminal identification information to other content playback apparatuses, and requests transmission of playback interruption information corresponding to the terminal identification information. When receiving the transmission request for the playback interruption information from the second content playback apparatus, playback interruption transmitting means of the first content playback apparatus reads the playback interruption information corresponding to the received terminal identification information from the storing means and transmits the read playback interruption information. Playback control means of the second content playback apparatus acquires the corresponding content in accordance with the transmitted playback interruption information, and causes the playback means to play back the acquired content.

According to the content playback system described above, a first content playback apparatus by which playback of content is interrupted receives terminal identification information from a portable terminal detected in accordance with a short-distance communication method, and stores, in association with the terminal identification information, playback interruption information including content identification information on the interrupted content. Then, when a second content playback apparatus detects the portable terminal, the terminal identification information of the portable terminal is transmitted to the second content playback apparatus. The second content playback apparatus that receives the terminal identification information acquires playback interruption information by querying other content playback apparatuses as to the terminal identification information. The second content playback apparatus plays back the corresponding content in accordance with the acquired playback interruption information. Thus, playback of the interrupted content is continued. As described above, by causing each of the content playback apparatuses to detect the portable terminal in accordance with the short-distance communication method, the user does not need to perform a setting operation, for example, for selecting content to be played back. Thus, playback of the same content can be continued by the second content playback apparatus with a simple operation.

### BRIEF DESCRIPTION OF THE DRAWINGS

FIG. 1 schematically shows an example of the structure of an AV server system according to an embodiment of the present invention;

FIG. 2 is a block diagram showing an example of the internal structure of an HDD recorder;

FIG. 3 is a block diagram showing an example of the internal structure of a network AV player;

FIG. 4 is a block diagram showing an example of the internal structure of a portable terminal;

FIG. 5 schematically shows a first example of a continuous playback operation;

FIG. 6 shows a processing sequence performed when playback of content is interrupted in the first example of the continuous playback operation;

FIG. 7 shows a processing sequence performed when another playback apparatus starts continuous playback of the content in the first example of the continuous playback operation;

FIG. 8 schematically shows a second example of a continuous playback operation;

FIG. 9 shows a processing sequence performed when playback of content is interrupted in the second example of the continuous playback operation; and

FIG. 10 shows a processing sequence performed when another playback apparatus starts continuous playback of the content in the second example of the continuous playback operation.

### DESCRIPTION OF THE PREFERRED EMBODIMENTS

Embodiments of the present invention will be described with reference to the drawings. An audio visual (AV) server system according to an embodiment of the present invention capable of distributing video and audio content from an AV server to a client terminal in each room using a LAN system installed at home will be described as an example.

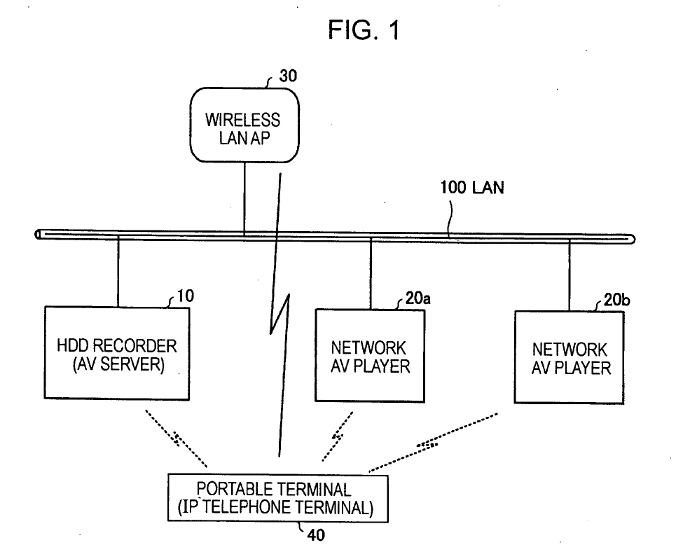

FIG. 1 shows an example of the structure of the AV server system according to this embodiment. In the AV server system shown in FIG. 1, an HDD recorder 10 having a function as an AV server, network AV players 20a and 20b functioning as client terminals, and a wireless LAN access point 30 are connected to each other via a LAN 100. A portable terminal 40 is capable of performing communication via the LAN 100 by being wirelessly connected to the LAN 100 via the wireless LAN access point 30.

The HDD recorder 10 has a function to convert content received, for example, via broadcast radio waves, into digital data, to store the digital data onto an HDD contained in the HDD recorder 10, and to play back the content. The HDD recorder 10 also has a function to distribute the stored content via the LAN 100 to the network AV players 20a and 20b by streaming. Each of the network AV players 20a and 20b has a function to play back, in real time, the content distributed from the HDD recorder 10 via the LAN 100.

The wireless LAN access point 30 is connected to the LAN 100 via a wired cable. Since a wireless LAN remote station (in this example, the portable terminal 40) is wirelessly connected to this circuit, the wireless LAN access point 30 functions as a master station. In addition, the wireless LAN access point 30 may have various security functions necessary for radio transmission and reception.

The portable terminal 40 functions as a remote station to be connected to the LAN 100 via the wireless LAN access point 30. In this embodiment, the portable terminal 40 functions as a conversation terminal of an Internet protocol (IP) telephone service based on a voice over Internet protocol (VoIP) due to connection with the wireless LAN access point 30. In addition; the portable terminal 40 is provided with a communication interface for short-distance wireless communication. Thus, the portable terminal 40 is capable of performing non-contact communication with the HDD recorder 10 and the network AV players 20a and 20b via short-distance wireless communication.

In the AV server system, for example, the HDD recorder 10, the network AV player 20a, and the network AV player 20b are installed in different rooms, and content stored in an AV player can be viewed or listened to in any room in which the HDD recorder 10, the network AV player 20a, or the network AV player 20b is installed. In addition, the portable terminal 40 is capable of communicating with the HDD recorder 10 and the network AV players 20a and 20b via short-distance wireless communication. When the HDD recorder 10, the network AV player 20a, or the network AV player 20b executes an application for content playback processing (recording processing, channel selection processing, and the like may be included for the HDD recorder 10), the HDD recorder 10, the network AV player 20a, or the network AV player 20b detects the portable terminal 40 via short-distance wireless communication. When the portable terminal 40 is authenticated, the HDD recorder 10, the network AV player 20a, or the network AV player 20b is capable of transmitting and receiving information to and from the portable terminal 40 via short-distance wireless communication. Alternatively, then, the HDD recorder 10, the network AV player 20a, or the network AV player 20b is capable of receiving, for example, a control command from the portable terminal 40 by being connected to the portable terminal 40 via the LAN 100, and performing an operation.

In this embodiment, in particular, when a playback operation of one of playback apparatuses, that is, one of the HDD recorder 10, the network AV player 20a, and the network AV player 20b is interrupted during the playback of content, the use of the portable terminal 40 allows playback of the content to be continued by another playback apparatus with a simple operation. Hereinafter, such an operation will be referred to as a “continuous playback operation” and the portable terminal 40 functions as an “electronic bookmark terminal” that holds identification information of content whose playback is interrupted and information on the interrupted position (or information necessary for acquiring such information when playback resumes).

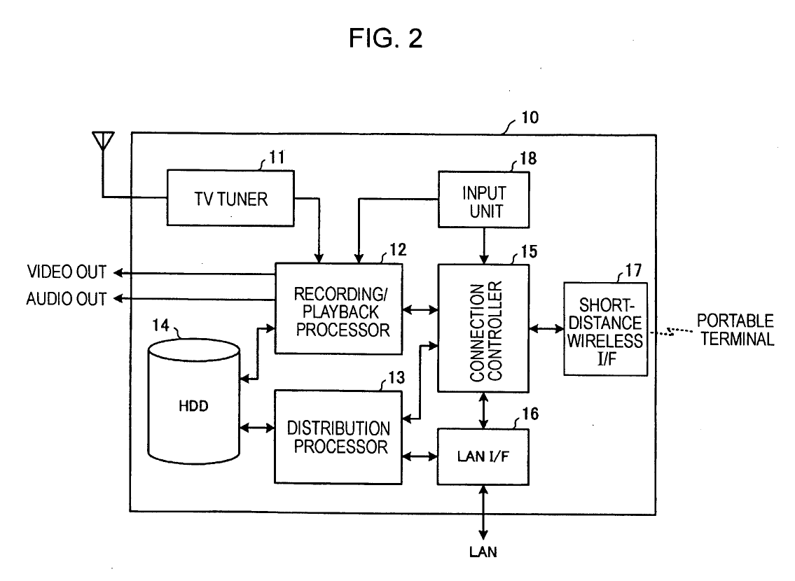

FIG. 2 is a block diagram showing an example of the internal structure of the HDD recorder 10.

Referring to FIG. 2, the HDD recorder 10 includes a television (TV) tuner 11, a content recording/playback processor 12, a content distribution processor 13, an HDD 14, a connection controller 15, a LAN interface 16, a short-distance wireless interface 17, and an input unit 18.

The TV tuner 11 receives broadcast radio waves, and selects and demodulates a signal in a broadcast channel designated via the recording/playback processor 12. The TV tuner 11 converts the demodulated signal into video and audio digital data, and supplies the video and audio digital data to the recording/playback processor 12.

The recording/playback processor 12 receives content via the TV tuner 11 and performs an operation for recording and playing back the content onto and from the HDD 14 in accordance with a control signal input via the input unit 18 or the connection controller 15.

When content is recorded, content received and converted into digital data by the TV tuner 11 is input to the recording/playback processor 12. The recording/playback processor 12 encodes the content in accordance with a predetermined format, such as moving picture experts group (MPEG) 2, and records the encoded content onto the HDD 14 as stream data. For example, content input from an external input terminal or content received via the LAN interface 16 may be recorded onto the HDD 14.

When content is played back, the recording/playback processor 12 decodes stream data read from the HDD 14, and converts the decoded data into analog data. The recording/playback processor 12 outputs the analog data to an external monitor, an audio amplifier, or the like via an output terminal. Thus, a user is able to view or listen to the content.

The distribution processor 13 performs server processing of distributing content within the HDD 14 to another playback apparatus connected to the LAN 100. More specifically, the distribution processor 13 receives designation of content and a distribution request for the content from the network AV player 20a or 20b via the LAN interface 16, reads stream data of the corresponding content from the HDD 14, and sequentially transmits, via the LAN interface 16, the read stream data to the network AV player 20a or 20b, which is a request source.

The connection controller 15 executes various applications using the portable terminal 40 detected by the short-distance wireless interface 17. For example, the connection controller 15 controls an operation of the recording/playback processor 12 for recording and playing back content and an operation of the distribution processor 13 in accordance with a control command received from the portable terminal 40 via the short-distance wireless interface 17 or the LAN interface 16. In this case, the portable terminal 40 is capable of functioning as a remote controller for the HDD recorder 10. In this embodiment, in particular, the connection controller 15 performs processing for realizing a continuous playback operation between the above-mentioned playback apparatuses. In addition, the connection controller 15 performs authentication processing and apparatus management processing for the portable terminal 40 detected by the short-distance wireless interface 17.

The LAN interface 16 controls signal transmission and reception via the LAN 100. The short-distance wireless interface 17 is an interface used for communicating with the portable terminal 40 via short-distance wireless communication. In this embodiment, an electromagnetic induction communication method using a wireless IC chip is adopted as a short-distance wireless communication method. The short-distance wireless interface 17 includes a reader/writer that performs power supply and signal transmission and reception to and from the wireless IC chip provided in the portable terminal 40. The input unit 18 includes an input key and the like. The input unit 18 outputs to the connection controller 15 or the recording/playback processor 12 a control signal based on an input user operation.

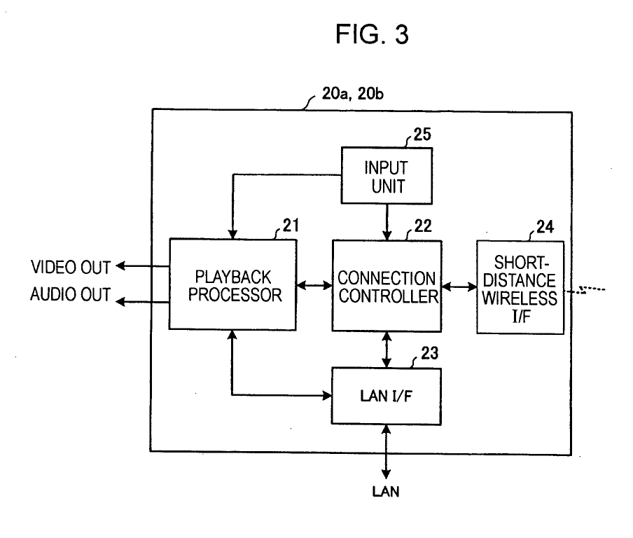

FIG. 3 is a block diagram showing an example of the internal structure of the network AV player 20a or 20b.

The network AV players 20a and 20b have the same structure. Referring to FIG. 3, each of the network AV players 20a and 20b includes a content playback processor 21, a connection controller 22, a LAN interface 23, a short-distance wireless interface 24, and an input unit 25.

The playback processor 21 performs playback processing for content distributed from the HDD recorder 10. More specifically, the playback processor 21 receives distributed stream data of content via the LAN interface 23, decodes the stream data in accordance with a predetermined format, converts the decoded data into an analog signal, and outputs the analog signal to an external monitor, an audio amplifier, or the like via an output terminal.

The connection controller 22 is a functional block corresponding to the connection controller 15 of the HDD recorder 10. The connection controller 22 performs processing of various applications using the portable terminal 40 detected by the short-distance wireless interface 24, such as an operation of the playback processor 21 for playing back content and a continuous playback operation between playback apparatuses, and processing for authentication and apparatus management for the portable terminal 40.

The LAN interface 23 controls signal transmission and reception via the LAN 100. The short-distance wireless interface 24 is an interface used for communicating with the portable terminal 40 via short-distance wireless communication. In this embodiment, similarly to the HDD recorder 10, the short-distance wireless interface 24 performs communication based on the electromagnetic induction communication method using a wireless IC chip, and includes a reader/writer that performs power supply and signal transmission and reception to and from the wireless IC chip provided in the portable terminal 40. The input unit 25 includes an input key and the like. The input unit 25 outputs to the connection controller 22 or the playback processor 21 a control signal based on an input user operation.

The HDD recorder 10, the network AV player 20a, and the network AV player 20b each have a function to execute various applications using the portable terminal 40. In a case where the portable terminal 40 is usable, for example, when the portable terminal 40 approaches the HDD recorder 10, the short-distance wireless interface 17 detects the portable terminal 40 and reports to the connection controller 15 a detection result. The connection controller 15 performs authentication with the portable terminal 40 via the short-distance wireless interface 17. If authentication is successfully achieved, the HDD recorder 10 receives a control signal from the portable terminal 40 via the short-distance wireless interface 17 or the LAN interface 16. Thus, the HDD recorder 10 is capable of controlling predetermined processing, such as a content recording operation and a continuous playback operation.

Such a function may be prepared as an apparatus independent of the HDD recorder 10, the network AV player 20a, or the network AV player 20b. In this case, for example, the HDD recorder 10, the network AV player 20a, and the network AV player 20b each include an interface for the LAN 100 and performs transmission and reception of video and audio data by communicating with another apparatus on the network. In addition, the function of the connection controller 15 or 22 and the function of the short-distance wireless interface 17 or 24 are prepared as an external expansion device. By connecting such an expansion device to the HDD recorder 10, the network AV players 20a, or the network AV player 20b via a communication medium, such as a universal serial bus (USB), communication via the LAN 100 by the HDD recorder 10, the network AV player 20a, or the network AV player 20b is performed through the expansion device. Thus, each of the HDD recorder 10, the network AV player 20a, and the network AV player 20b is capable of using the portable terminal 40 as a control terminal.

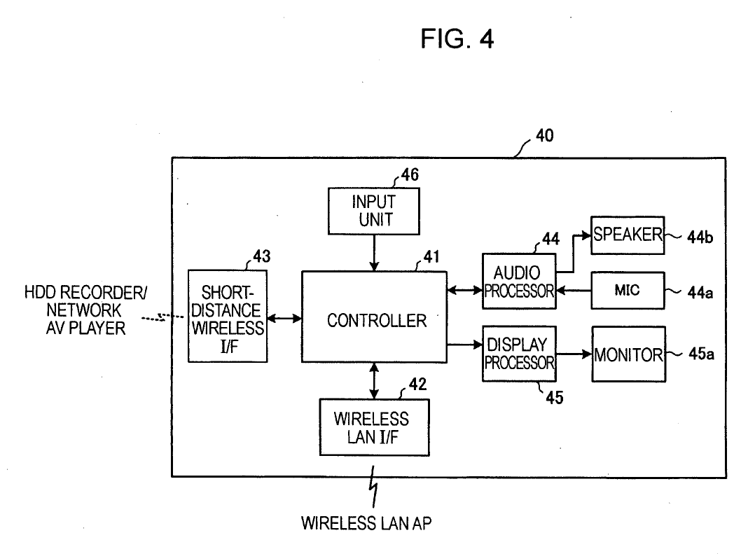

FIG. 4 is a block diagram showing an example of the internal structure of the portable terminal 40.

Referring to FIG. 4, the portable terminal 40 includes a controller 41, a wireless LAN interface 42, a short-distance wireless interface 43, an audio processor 44, a display processor 45, a microphone 44a, a speaker 44b, a monitor 45a, and an input unit 46.

The controller 41 includes a central processing unit (CPU), a memory in which programs and various data executed by the CPU are stored, and the like. The controller 41 generally controls each block within the portable terminal 40. More specifically, the controller 41 performs conversation processing over IP telephone via the wireless LAN interface 42, in other words, outputs to the wireless LAN interface 42 an audio signal received from the audio processor 44 and outputs to the audio processor 44 an audio signal received via the wireless LAN interface 42. In addition, the controller 41 performs processing of transmitting and receiving various data, such as address information and a control command, via the wireless LAN interface 42 or the short-distance wireless interface 43, processing of generating display information for the monitor 45a and outputting the display information to the display processor 45, and the like.

The wireless LAN interface 42 is an interface circuit for connecting the portable terminal 40 to the LAN 100 via the wireless LAN access point 30. The wireless LAN interface 42 demodulates a signal received from the wireless LAN access point 30, and supplies the demodulated signal to the controller 41. The wireless LAN interface 42 also modulates a signal output from the controller 41, and wirelessly transmits the modulated signal to the wireless LAN access point 30.

The short-distance wireless interface 43 includes a wireless IC chip for communication based on the electromagnetic induction communication method, an antenna used for signal transmission and reception, a semiconductor memory that stores transmission and reception information, and the like. The short-distance wireless interface 43 operates by generating electric power in accordance with radio waves received from the reader/writer (the short-distance wireless interface 17 or 24) provided in the HDD recorder 10, the network AV player 20a, or the network AV player 20b, and transmits and receives signals to and from the HDD recorder 10, the network AV player 20a, or the network AV player 20b.

The audio processor 44 converts an audio signal received from the microphone 44a into a digital signal, encodes the digital signal into a predetermined format, and outputs the encoded signal to the controller 41. In addition, the audio processor 44 decodes an audio signal received from the controller 41 into an analog signal, and outputs the analog signal to the speaker 44b to be played back. The display processor 45 generates a video signal in accordance with display information generated by the controller 41, and outputs the video signal to the monitor 45a, which is, for example, a liquid crystal display (LCD), to be displayed. The input unit 46 includes an input key and the like. The input unit 46 outputs to the controller 41 a control signal based on an input user operation.

As described above, the portable terminal 40 functions as an electronic bookmark terminal used by a user to change a playback apparatus that plays back content. This function may be installed in a portable information processor, such as a personal digital assistant (PDA) or a remote controller for each playback apparatus, instead of the telephone terminal described in this embodiment. However, when the portable terminal 40 is used as an electronic bookmark terminal, a user carries the portable terminal 40 with him or her when moving between rooms. Thus, it is preferable that such a function be installed in an apparatus owned by each individual, such as a telephone terminal, or an apparatus that each user normally carries with him or her.

Although the electromagnetic induction communication method is adopted as a short-distance wireless communication method for direct communication with each of the HDD recorder 10, the network AV player 20a, and the network AV player 20b in this embodiment, for example, Bluetooth™ or infrared-ray communication may be used. In addition, instead of wireless communication, a communication method using a relatively short wired-cable, such as a USB or IEEE (institute of electrical and electronic engineers) 1394, may be used.

An operation performed by such an AV server system, for example, when a continuous playback operation is performed between the HDD recorder 10 and the network AV player 20a will now be described.

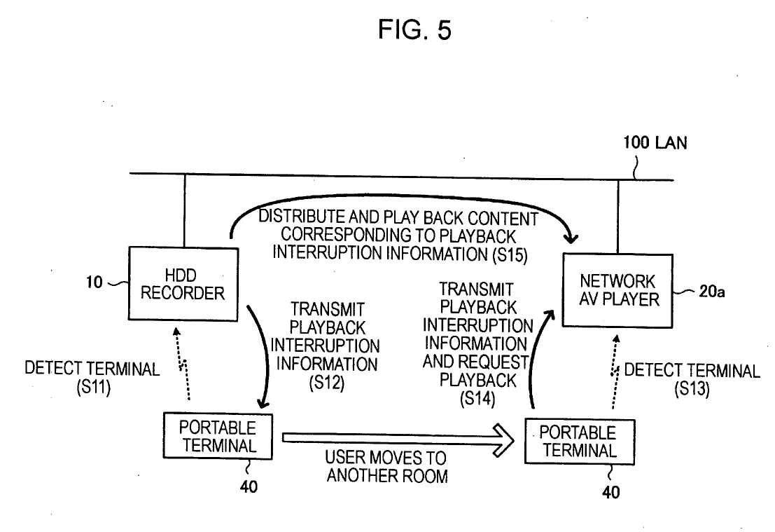

FIG. 5 schematically shows a first example of a continuous playback operation.

For example, in the HDD recorder 10, content within the HDD 14 is being played back. When playback of the content needs to be interrupted, a user brings the portable terminal 40 closer to the HDD recorder 10, so that the HDD recorder 10 can detect the portable terminal 40 via short-distance communication (S11). When the HDD recorder 10 detects the portable terminal 40 via the short-distance wireless interface 17, the HDD recorder 10 performs authentication processing with the portable terminal 40. Then, the HDD recorder 10 interrupts playback of the content, generates playback interruption information indicating information on the playback interruption, and transmits the playback interruption information to the portable terminal 40 (step S12). Here, the playback interruption information may be transmitted via short-distance wireless communication or via the LAN 100 using the wireless LAN access point 30.

The playback interruption information includes, for example, content identification information (for example, the title name or ID of a CD album, a track number, or directory information of a corresponding file within the HDD recorder 10) for identifying the content whose playback is interrupted, interrupted position information (for example, elapsed time information of a track) indicating a playback position of the content when playback is interrupted, the IP address of an apparatus from which the content is distributed (in this case, the HDD recorder 10).

After the portable terminal 40 receives and stores the transmitted playback interruption information, the user carries the portable terminal 40 with him or her to another room. Then, the user brings the portable terminal 40 closer to the network AV player 20a, which is installed in the room to which the user moves, so that the network AV player 20a can detect the portable terminal 40 (step S13). When the network AV player 20a detects the portable terminal 40 via the short-distance wireless interface 24, the network AV player 20a performs authentication processing with the portable terminal 40. When authentication is successfully achieved, the portable terminal 40 transmits the playback interruption information to the network AV player 20a, and requests the network AV player 20a to continue playback of the content whose playback is interrupted (step S14). Here, the playback interruption information and the playback request may be transmitted via short-distance wireless communication or via the LAN 100 using the wireless LAN access point 30.

The network AV player 20a requests, in accordance with the received playback interruption information, the HDD recorder 10, which is a distribution source, to distribute the content whose playback is interrupted. Here, the network AV player 20a can request the HDD recorder 10 to start distribution from a particular position in accordance with the interrupted position information. In response to the distribution request, the HDD recorder 10 distributes the corresponding content to the network AV player 20a by streaming, and the network AV player 20a starts to play back the distributed content (step S15).

According to the above-described procedure, by bringing the portable terminal 40 closer to each of an apparatus by which playback is interrupted and the next apparatus by which playback is to be continued, continuous playback of the same content can be realized without directly operating each apparatus. In addition, when interrupted position information of the content is included in playback interruption information, the next apparatus is capable of starting playback of the content from the position where playback is interrupted. Thus, the user is able to perform such a continuous playback operation by performing a simple operation using the portable terminal 40.

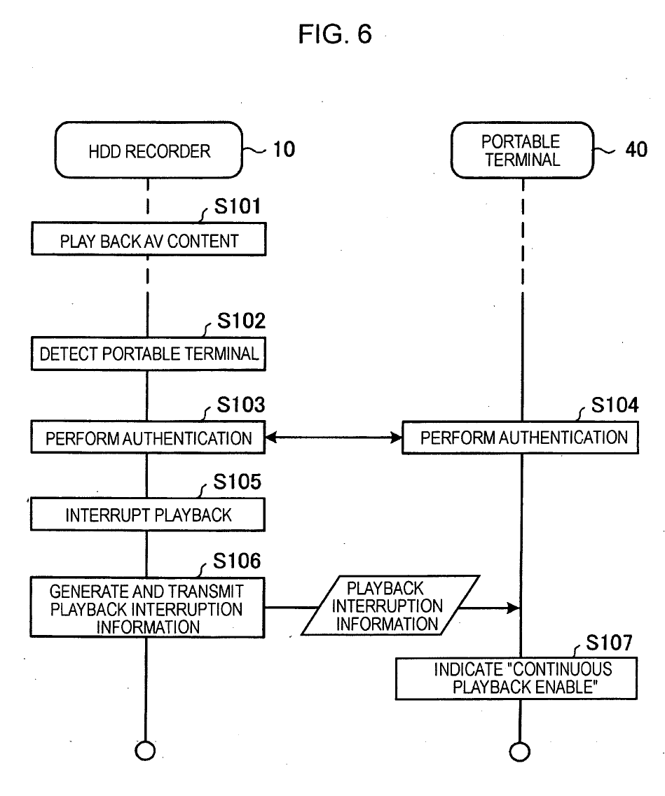

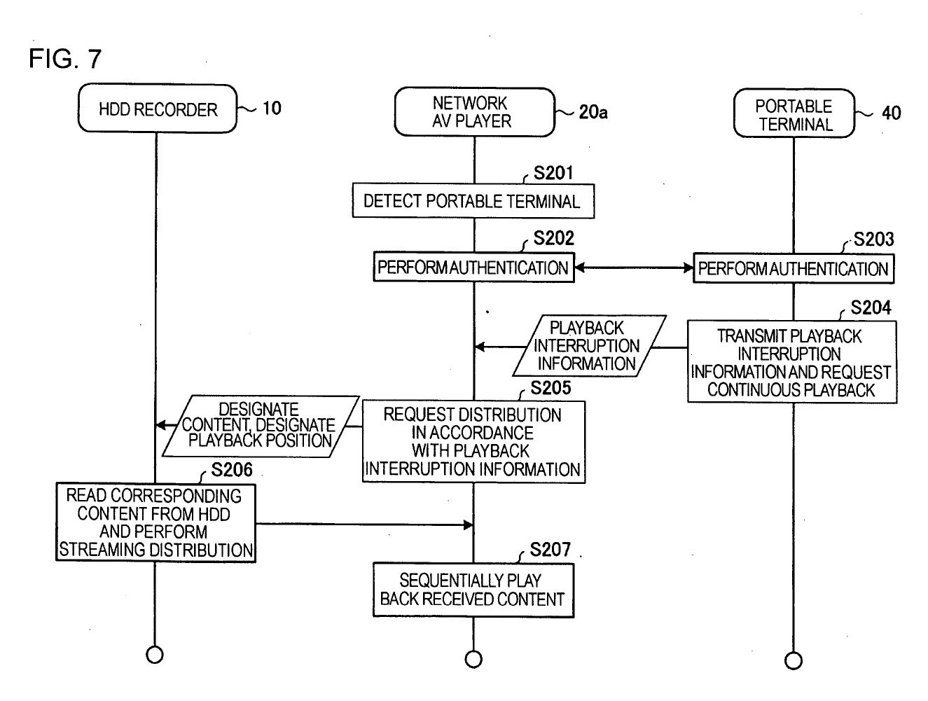

The above-described operation will be described more in detail with reference to FIGS. 6 and 7.

FIG. 6 shows a processing sequence performed when playback of content is interrupted.

Referring to FIG. 6, in the initial state, in the HDD recorder 10, predetermined content stored in the HDD 14 is being played back (step S101). When the user brings the portable terminal 40 closer to the HDD recorder 10, the HDD recorder 10 detects the portable terminal 40 via the short-distance wireless interface 17 (step S102). Necessary information is transferred between the HDD recorder 10 and the HDD 14 via short-distance wireless communication, and authentication processing is performed (steps S103 and S104). When authentication is successfully achieved, communication via the LAN 100 can be performed between the portable terminal 40 and the HDD recorder 10 using IP addresses exchanged in the authentication processing.

In the authentication processing, for example, the HDD recorder 10 receives in advance registration of the portable terminal 40 that is capable of functioning as an electronic bookmark terminal. Alternatively, such registration may be performed for another management server on the LAN 100 so that authentication can be received by accessing the management server in accordance with authentication information when the HDD recorder 10 detects the portable terminal 40.

When the HDD recorder 10 successfully achieves authentication by the processing of the connection controller 15, the connection controller 15 requests the recording/playback processor 12 to stop playback, and an operation for playing back the content is interrupted (step S105). Here, for example, playback may be automatically interrupted after authentication is successfully achieved. However, for example, after authentication is successfully achieved, a request for stopping playback may be transmitted via the LAN 100 in accordance with a user operation input to the portable terminal 40, and playback may be interrupted in accordance with the request for stopping playback. Alternatively, after playback is stopped by a direct user operation for the HDD recorder 10, when the portable terminal 40 is detected and authenticated, processing in step S106 and the subsequent processing may be performed.

When playback is stopped, the connection controller 15 receives from the recording/playback processor 12 content identification information and interrupted position information of content whose playback is interrupted, generates playback interruption information in accordance with the received content identification information and interrupted position information, and transmits the generated playback interruption information to the portable terminal 40 via the LAN interface 16 (step S106). The portable terminal 40 receives the playback interruption information via the LAN 100, and stores the playback interruption information, for example, into a random-access memory (RAM) within the controller 41. Then, the portable terminal 40 enters a standby state for causing another playback apparatus to continue playback. For example, the portable terminal 40 reports to the user, by display on the monitor 45a, that continuous playback can be performed (step S107).

FIG. 7 shows a processing sequence performed when another playback apparatus (in this case, the network AV player 20a) starts continuous playback of the content.

After the processing sequence shown in FIG. 6 is completed, the user carries the portable terminal 40 with him or her to the room where the network AV player 20a is installed, and brings the portable terminal 40 closer to the network AV player 20a. Then, the network AV player 20a detects the portable terminal 40 via the short-distance wireless interface 24 (step S201). Authentication processing similar to the processing in steps S103 and S104 shown in FIG. 6 is performed between the network AV player 20a and the portable terminal 40 (steps S202 and S203).

When authentication is successfully achieved, the network AV player 20a and the portable terminal 40 are capable of communicating with each other via the LAN 100. The portable terminal 40 transmits the stored playback interruption information to the network AV player 20a via the wireless LAN interface 42 (step S204). The network AV player 20a transmits, by the processing of the connection controller 22, to the HDD recorder 10 via the LAN 100 a distribution request in which the content whose playback is to be continued and a playback start position of the content are designated in accordance with the received playback interruption information (step S205). Here, for example, after the user performs a distribution request operation for the portable terminal 40, the network AV player 20a that receives the request via the LAN 100 may request distribution. However, when the network AV player 20a holds the playback interruption information, if distribution can be automatically requested after authentication is successfully achieved, a user operation can be simplified and user-friendliness can be further improved.

When receiving the distribution request, the HDD recorder 10 reads the corresponding content from the HDD 14 by the processing of the distribution processor 13, and starts streaming distribution from the designated position to the network AV player 20a (step S206). The network AV player 20a sequentially plays back the received content (step S207). Thus, the network AV player 20a is capable of performing continuous playback of the same content from the position where playback is interrupted by the HDD recorder 10.

In accordance with the processing described above, the user does not need to perform an operation for setting information on content whose playback is interrupted and an interrupted position of the content. By a simple and intuitive operation for bringing the portable terminal 40 closer to the apparatus by which playback is interrupted and to the apparatus by which playback is to be continued in that order, playback of the content interrupted by the previous apparatus can be continued by the subsequent apparatus.

Although a case where a playback operation is shifted from the HDD recorder 10 to the network AV player 20a is described in the first example of the continuous playback operation, this operation example may also be applicable to a case where the playback operation is shifted from the network AV player 20a to the HDD recorder 10. In this case, playback interruption information generated in the network AV player 20a is stored into the portable terminal 40. The HDD recorder 10 by which playback is to be continued reads Corresponding content from the HDD 14 contained in the HDD recorder 10 in accordance with the playback interruption information, and plays back the read content by the processing of the recording/playback processor 12. In addition, this operation example can also be applied to a case where the playback operation is shifted between the network AV player 20a and the network AV player 20b.

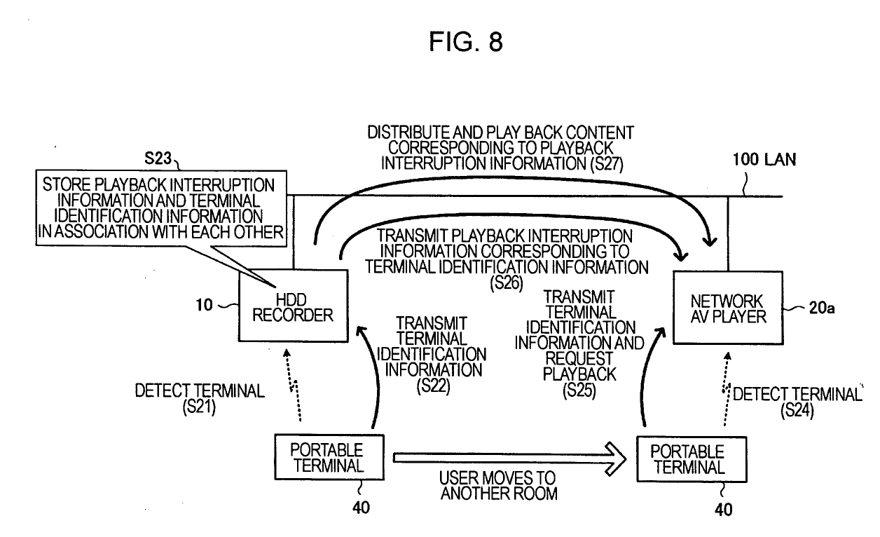

FIG. 8 schematically shows a second example of the continuous playback operation.

In the second example of the continuous playback operation, the portable terminal 40 stores terminal identification information for identifying itself. The terminal identification information is, for example, an IP address or a media access control (MAC) address assigned to the portable terminal 40. Such terminal identification information is stored, for example, in a memory within the short-distance wireless interface 43. Alternatively, such terminal identification information may be temporary information, such as key information or time information, generated when the information is transmitted.

In a state in which content within the HDD 14 of the HDD recorder 10 is being played back, the user brings the portable terminal 40 closer to the HDD recorder 10, so that the HDD recorder 10 can detect the portable terminal 40 via short-distance communication (step S21). After the portable terminal 40 is detected, the portable terminal 40 transmits terminal identification information on the portable terminal 40 via short-distance wireless communication or via the LAN 100 (step S22). The HDD recorder 10 generates playback interruption information indicating information on playback interruption, and stores, for example, into the HDD 14 the playback interruption information in association with the terminal identification information received from the portable terminal 40 (step S23).

Then, the user carries the portable terminal 40 with him or her to the room where the network AV player 20a is installed. The user brings the portable terminal 40 closer to the network AV player 20a, so that the network AV player 20a can detect the portable terminal 40 via short-distance wireless communication (step S24). After the network AV player 20a detects the portable terminal 40, the portable terminal 40 transmits the terminal identification information of the portable terminal 40 to the network AV player 20a via short-distance wireless communication or via the LAN 100, and requests the network AV player 20a to continue playback of the content whose playback is interrupted (step S25).

The network AV player 20a transmits the received terminal identification information to each apparatus on the LAN 100. In response to this, the HDD recorder 10 transmits to the network AV player 20a the playback interruption information corresponding to the received terminal identification information (step S26). In accordance with the received playback interruption information, the network AV player 20a requests the HDD recorder 10 to distribute the content. In response to the request, the HDD recorder 10 starts distributing the corresponding content by streaming, and the network AV player 20a plays back the distributed content (step S27).

According to the above-described procedure, as in the first example of the continuous playback operation, by bringing the portable terminal 40 closer to a corresponding playback apparatus when playback is interrupted and to a corresponding playback apparatus when playback is resumed, continuous playback of the same content can be realized without directly operating each apparatus, and playback can be started from the position where playback is interrupted. In addition, since information that is uniquely assigned in advance to the portable terminal 40 as terminal identification information, such as a MAC address, is used, a memory that stores such information does not need to be rewritable. Thus, the hardware structure of the portable terminal 40 can be simplified, and the production cost can be reduced.

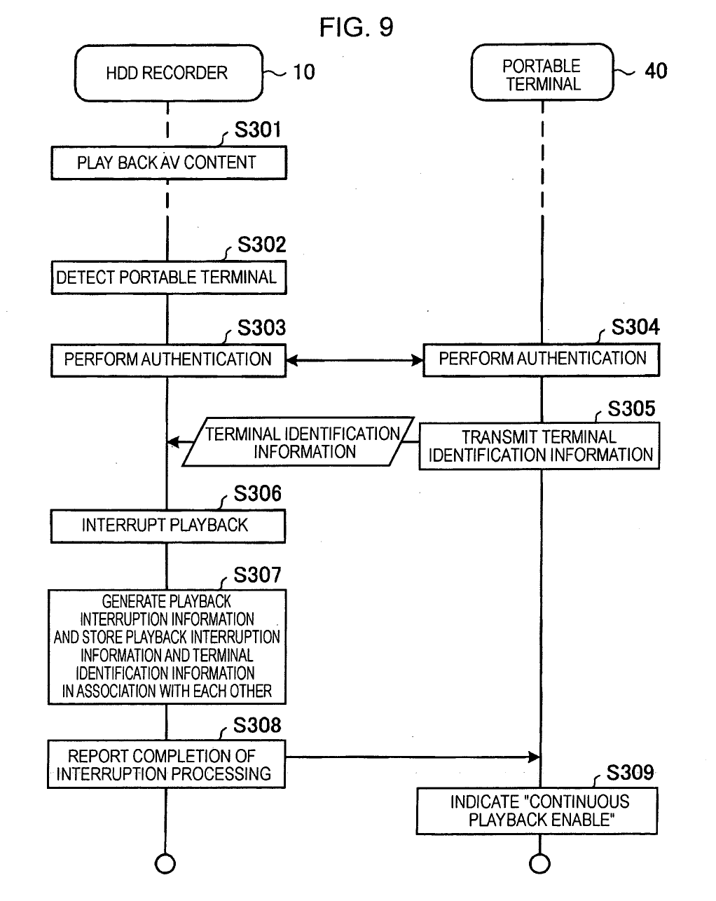

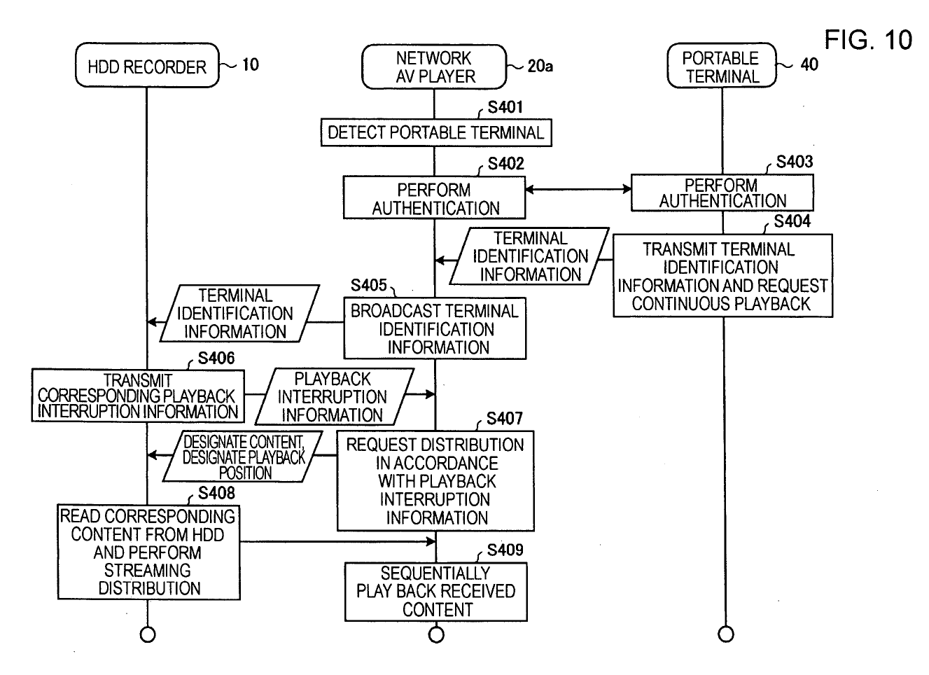

The above-described operation will be described more in detail with reference to FIGS. 9 and 10.

FIG. 9 shows a processing sequence performed when playback of the content is interrupted.

In a state in which predetermined content stored in the HDD 14 of the HDD recorder 10 is being played back (step S301), the user brings the portable terminal 40 closer to the HDD recorder 10, so that the HDD recorder 10 detects the portable terminal 40 via the short-distance wireless interface 17 (step S302). Authentication processing is performed between the HDD recorder 10 and the portable terminal 40 (steps S303 and S304). When authentication is successfully achieved, the portable terminal 40 transmits terminal identification information to the HDD recorder 10 (step S305).

When receiving the terminal identification information, the HDD recorder 10 interrupts playback of the content (step S306). The HDD recorder 10 generates playback interruption information on the interrupted content, and stores into the HDD 14 or the like the generated playback interruption information in association with the terminal identification information received from the portable terminal 40 (step S307). Then, the HDD recorder 10 reports to the portable terminal 40 that playback interruption processing is completed (step S308). The portable terminal 40 enters a standby state for causing another playback apparatus to continue playback. For example, the portable terminal 40 reports to the user, by display on the monitor 45a, that continuous playback can be performed (step S309).

In the processing in steps S303 to S305, as in the first example of the continuous playback operation shown in FIG. 6, after the portable terminal 40 and the HDD recorder 10 enter a state in which communication between the portable terminal 40 and HDD recorder 10 via the LAN 100 can be performed by successful authentication, the terminal identification information may be transferred by communication via the LAN 100. In this case, for example, the portable terminal 40 may automatically transmit the terminal identification information when authentication is successfully achieved. Alternatively, the portable terminal 40 may transmit the terminal identification information in accordance with a user operation after authentication is successfully achieved.

In addition, in a case where the terminal identification information is used as authentication information for the HDD recorder 10 when authentication processing is performed, the HDD recorder 10 can perform processing of step S307 using the terminal identification information, such as an IP address or a MAC address, received via short-distance wireless communication when authentication processing is performed. Thus, communication via the LAN 100 in step S305 is not necessary.

FIG. 10 shows a processing sequence performed when another playback apparatus (in this case, the network AV player 20a) starts continuous playback of the content.

After the processing sequence shown in FIG. 9 is completed, the user carries the portable terminal 40 with him or her to the room where the network AV player 20a is installed. The user brings the portable terminal 40 closer to the network AV player 20a. The network AV player 20a detects the portable terminal 40 via the short-distance wireless interface 24 (step S401), and authentication processing is performed between the network AV player 20a and the portable terminal 40 (steps S402 and 403). When authentication is successfully achieved, the portable terminal 40 transmits the terminal identification information to the network AV player 20a (step S404).

When receiving the terminal identification information, the network AV player 20a broadcasts to each apparatus on the LAN 100 a query for retrieving playback interruption information corresponding to the terminal identification information (step S405). In response to the query, the HDD recorder 10, which stores the identical terminal identification information, transmits the playback interruption information that is associated with the terminal identification information to the network AV player 20a via the LAN 100 (step S406).

Subsequently, as in the first example of the continuous playback operation, the network AV player 20a transmits to the HDD recorder 10 via the LAN 100 a distribution request in which the content whose playback is to be continued and a playback start position of the content are designated in accordance with the received playback interruption information (step S407). When receiving the distribution request, the HDD recorder 10 reads the corresponding content from the HDD 14, and starts streaming distribution from the designated position to the network AV player 20a (step S408). The network AV player 20a sequentially plays back the received content (step S409). Thus, the network AV player 20a is capable of performing continuous playback of the same content from the position where playback is interrupted by the HDD recorder 10.

In the processing in steps S402 to S404, as in the processing in steps S303 to S305 shown in FIG. 9, the terminal identification information may be transmitted via the LAN 100 after authentication is successfully achieved. Alternatively, the terminal identification information may be transmitted to the network AV player 20a when authentication processing is performed.

In accordance with the processing described above, the user does not need to perform an operation for setting information on content whose playback is interrupted and an interrupted position of the content. By an intuitive and simple operation using the portable terminal 40, playback of content whose playback is interrupted by a playback apparatus can be continued from the interrupted position by another playback apparatus.

Not only in a case where the playback operation is shifted from the HDD recorder 10 to the network AV player 20a, but also in cases where the playback operation is shifted from the network AV player 20a to the HDD recorder 10 and where the playback operation is shifted between the network AV player 20a and the network AV player 20b, continuous playback can be realized by transmitting terminal identification information from the portable terminal 40 to each playback apparatus, as described above.

In addition, the second example of the continuous playback operation may also be applied to a case where each playback apparatus stores data of content to be played back, as well as a system in which content is distributed from a server. For example, when playback of content in a first playback apparatus is interrupted and playback is to be continued by a second playback apparatus, the second playback apparatus queries, on the network, as to terminal identification information received from the portable terminal 40. In response to the query, the first playback apparatus transmits playback interruption information to the second playback apparatus. If the corresponding content is stored in the second playback apparatus, the second playback apparatus reads the content and starts playback of the content from the designated position in accordance with the playback interruption information. In this case, continuous playback can also be performed without performing an operation for designating content and a playback position using the second playback apparatus.

In addition, the second example of the continuous playback operation is also applicable to a case where, for example, content stored in a portable storage medium, such as an optical disc, is played back. For example, an optical disc used in the first playback apparatus is ejected. The optical disc is inserted into the second playback apparatus, and continuous playback is performed. If compressed data of mass content is recorded in the optical disc, an operation for selecting desired content from the mass content can be eliminated.

In addition, the second example of the continuous playback operation is also applicable to channel selection of broadcast content received via, for example, broadcast radio waves, as well as content stored in a storage medium. For example, when viewing on a first TV receiver is interrupted, the portable terminal 40 transmits terminal identification information to the first TV receiver. The first TV receiver includes a selected channel number in playback interruption information and stores the playback interruption information together with the terminal identification information. Then, when content in the same channel is viewed on a second TV receiver, the portable terminal 40 transmits the terminal identification information to the second TV receiver. The second TV receiver acquires the corresponding playback interruption information from the first TV receiver. The second TV receiver selects the same channel in accordance with the playback interruption information, and plays back the content. According to the above-described procedure, for example, in a case where a large number of selectable channels are provided, for example, for cable TV broadcasting or communications satellite (CS) broadcasting, not only a channel selection operation but an effort required for the user to remember the channel number can also be eliminated. Thus, user-friendliness can be improved.

However, for a system in which each TV receiver designates a reception channel to a server and the server transmits a reception signal in the selected channel to the TV receiver, a method in which the portable terminal 40 stores playback interruption information, as in the first example of the continuous playback operation, can also be applied.

In addition, although a continuous playback operation of video and audio content is described in the foregoing embodiment, the continuous playback operation can also be applied to other types of content, such as document data, diagram data, or a Web page. For document data, for example, when the number of a page and the number of a row are stored as playback position information within playback interruption information, if a corresponding document file is opened in another playback apparatus, the designated page and row can be displayed.

It should be understood by those skilled in the art that various modifications, combinations, sub-combinations and alterations may occur depending on design requirements and other factors insofar as they are within the scope of the appended claims or the equivalents thereof.

What is claimed is:

1. A content playback system comprising:
a content server that provides content;
a plurality of content playback apparatuses that plays back the content provided from the content server; and
a portable terminal that is capable of communicating with each of the plurality of content playback apparatuses at least in accordance with a short-distance communication method,
wherein each of the plurality of content playback apparatuses includes
playback means for playing back the content provided from the content server,
detecting means for detecting the portable terminal in accordance with the short-distance communication method,
transmitting means for transmitting to the portable terminal detected by the detecting means playback interruption information including content identification information for identifying the content when playback of the content by the playback means is interrupted, and
provision request means for receiving the playback interruption information from the portable terminal detected by the detecting means and for requesting the content server to provide the corresponding content in accordance with the playback interruption information, and
wherein the portable terminal includes
storing means for receiving and storing the playback interruption information from a first content playback apparatus that detects the portable terminal by the detecting means, and
playback request means for transmitting the playback interruption information stored in the storing means to a second content playback apparatus that detects the portable terminal by the detecting means after the portable terminal receives the playback interruption information and for requesting the second content playback apparatus to play back the corresponding content.

2. The content playback system according to claim 1, wherein:
the playback interruption information further includes interrupted position information indicating a playback position when playback of the content by the playback means is interrupted; and
the provision request means of each of the plurality of content playback apparatuses requests the content server for provision by designating content to be provided and a provision start position of the content in accordance with the received playback interruption information.

3. The content playback system according to claim 1, wherein each of the plurality of content playback apparatuses further includes authentication means for performing authentication processing for the portable terminal detected by the detecting means and for enabling the playback interruption information to be transmitted or received when authentication is successfully achieved.

4. The content playback system according to claim 3, wherein the transmitting means and the provision request means of each of the plurality of content playback apparatuses transmit or receive the playback interruption information in a communication method other than the method used by the detecting means when authentication is successfully achieved by the authentication means.

5. The content playback system according to claim 4, wherein the transmitting means and the provision request means of each of the plurality of content playback apparatuses transmit or receive the playback interruption information via a network used for provision of the content and for a provision request made by the provision request means.

6. A content playback system comprising:
a plurality of content playback apparatuses that plays back content; and
a portable terminal that is capable of communicating with each of the plurality of content playback apparatuses at least in accordance with a short-distance communication method,
wherein each of the plurality of content playback apparatuses includes
playback means for playing back the content,
detecting means for detecting the portable terminal in accordance with the short-distance communication method,
storing means for receiving from the portable terminal detected by the detecting means terminal identification information for identifying the portable terminal and for storing, in association with the received terminal identification information, playback interruption information including content identification information for identifying content whose playback is interrupted when playback of the content by the playback means is interrupted,
transmission request means for multicasting the terminal identification information to other content playback apparatuses and for requesting transmission of playback interruption information corresponding to the terminal identification information when the terminal identification information of the portable terminal and a playback request for the content are received from the portable terminal detected by the detecting means,
playback interruption information transmitting means for reading the playback interruption information corresponding to the received terminal identification information from the storing means and for transmitting the read playback interruption information when a transmission request for the playback interruption information is received from another content playback apparatus, and
playback control means for acquiring the corresponding content in accordance with the playback interruption information and for causing the playback means to play back the acquired content when the playback interruption information transmitted in response to the transmission request by the transmission request means is received, and
wherein the portable terminal includes
terminal identification information transmitting means for transmitting the terminal identification information of the portable terminal to a first content playback apparatus that detects the portable terminal by the detecting means, and
playback request means for transmitting the terminal identification information of the portable terminal to a second content playback apparatus and for requesting the second content playback apparatus to play back the corresponding content when the portable terminal is detected by the detecting means of the second content playback apparatus after the terminal identification information transmitting means transmits the terminal identification information.

7. The content playback system according to claim 6, wherein:
the playback interruption information further includes interrupted position information indicating a playback position when playback of the content by the playback means is interrupted; and
the playback control means of each of the plurality of content playback apparatuses acquires the content whose beginning position is based on the interrupted position information included in the received playback interruption information and causes the playback means to play back the acquired content.

8. The content playback system according to claim 6, wherein when the playback means of each of the plurality of content playback apparatuses plays back the content provided from a content server via a network, the playback control means requests, via the network, the content server to provide the corresponding content in accordance with the received playback interruption information and causes the playback means to play back the content provided in response to the request.

9. The content playback system according to claim 8, wherein each of the plurality of content playback apparatuses transmits the transmission request for the playback interruption information by the transmission request means and the playback interruption information by the playback interruption information transmitting means via the network used for provision of the content.

10. A content playback apparatus comprising:
playback means for playing back content provided from a content server;
detecting means for detecting a portable terminal in accordance with a short-distance communication method;
transmitting means for transmitting to the portable terminal detected by the detecting means playback interruption information including content identification information for identifying the content when playback of the content by the playback means is interrupted; and
provision request means for receiving the playback interruption information from the portable terminal detected by the detecting means and for requesting the content server to provide the corresponding content in accordance with the playback interruption information.

11. A content playback apparatus comprising:
playback means for playing back content;
detecting means for detecting a portable terminal in accordance with a short-distance communication method;
storing means for receiving from the portable terminal detected by the detecting means terminal identification information for identifying the portable terminal and for storing, in association with the received terminal identification information, playback interruption information including content identification information for identifying content whose playback is interrupted when playback of the content by the playback means is interrupted;
transmission request means for multicasting the terminal identification information to other content playback apparatuses and for requesting transmission of playback interruption information corresponding to the terminal identification information when the terminal identification information of the portable terminal and a playback request for the content are received from the portable terminal detected by the detecting means;
playback interruption information transmitting means for reading the playback interruption information corresponding to the received terminal identification information from the storing means and for transmitting the read playback interruption information when a transmission request for the playback interruption information is received from another content playback apparatus; and
playback control means for acquiring the corresponding content in accordance with the playback interruption information and for causing the playback means to play back the acquired content when the playback interruption information transmitted in response to the transmission request by the transmission request means is received.

12. A content playback method in a system including a content server and a plurality of content playback apparatuses that plays back the content provided from the content server, the method comprising the steps of:
detecting, by a first content playback apparatus, a portable terminal in accordance with a short-distance communication method;
interrupting, by the first content playback apparatus, playback of the content;
transmitting, by the first content playback apparatus, to the detected portable terminal playback interruption information including content identification information for identifying the content whose playback is interrupted;
storing, by the portable terminal, the playback interruption information;
detecting, by a second content playback apparatus, the portable terminal in accordance with the short-distance communication method;
requesting, by the portable terminal, the second content playback apparatus to play back the corresponding content by transmitting the playback interruption information to the second content playback apparatus that detects the portable terminal; and
requesting, by the second content playback apparatus, the content server to provide the corresponding content in accordance with the playback interruption information received from the detected portable terminal.

13. A content playback method in a system in which a plurality of content playback apparatuses that plays back content is connected to each other via a network, the method comprising the steps of:
detecting, by a first content playback apparatus, a portable terminal in accordance with a short-distance communication method;
transmitting, by the portable terminal, terminal identification information for identifying the portable terminal to the first content playback apparatus;
interrupting, by the first content playback apparatus, playback of the content and storing, in association with the terminal identification information received from the portable terminal, playback interruption information including content identification information for identifying the content;
detecting, by a second content playback apparatus, the portable terminal in accordance with the short-distance communication method;
requesting, by the portable terminal, the second content playback apparatus to play back the corresponding content by transmitting the terminal identification information of the portable terminal to the second content playback apparatus;
requesting, by the second content playback apparatus, transmission of playback interruption information corresponding to the terminal identification information by multicasting the terminal identification information to other content playback apparatuses connected on the network when the terminal identification information and a playback request for the content are received from the portable terminal;
transmitting, by the first content playback apparatus, the playback interruption information corresponding to the received terminal identification information in response to a transmission request for the playback interruption information; and
acquiring and playing back, by the second content playback apparatus, the corresponding content in accordance with the playback interruption information by receiving the playback interruption information transmitted in response to the transmission request.

14. A content playback system comprising:
a content server that provides content;
a plurality of content playback apparatuses that plays back the content provided from the content server; and
a portable terminal that is capable of communicating with each of the plurality of content playback apparatuses at least in accordance with a short-distance communication method,
wherein each of the plurality of content playback apparatuses includes
a playback unit that plays back the content provided from the content server,
a detection unit that detects the portable terminal in accordance with the short-distance communication method,
a transmission unit that transmits to the portable terminal detected by the detection unit playback interruption information including content identification information for identifying the content when playback of the content by the playback unit is interrupted, and
a provision request unit that receives the playback interruption information from the portable terminal detected by the detection unit and that requests the content server to provide the corresponding content in accordance with the playback interruption information, and
wherein the portable terminal includes
a storing unit that receives and stores the playback interruption information from a first content playback apparatus that detects the portable terminal by the detection unit, and
a playback request unit that transmits the playback interruption information stored in the storing unit to a second content playback apparatus that detects the portable terminal by the detection unit after the portable terminal receives the playback interruption information and that requests the second content playback apparatus to play back the corresponding content.

15. A content playback system comprising:
a plurality of content playback apparatuses that plays back content; and
a portable terminal that is capable of communicating with each of the plurality of content playback apparatuses at least in accordance with a short-distance communication method,
wherein each of the plurality of content playback apparatuses includes
a playback unit that plays back the content,
a detection unit that detects the portable terminal in accordance with the short-distance communication method,
a storing unit that receives from the portable terminal detected by the detection unit terminal identification information for identifying the portable terminal and that stores, in association with the received terminal identification information, playback interruption information including content identification information for identifying content whose playback is interrupted when playback of the content by the playback unit is interrupted,
a transmission request unit that multicasts the terminal identification information to other content playback apparatuses and that requests transmission of playback interruption information corresponding to the terminal identification information when the terminal identification information of the portable terminal and a playback request for the content are received from the portable terminal detected by the detection unit,
a playback interruption information transmission unit that reads the playback interruption information corresponding to the received terminal identification information from the storing unit and that transmits the read playback interruption information when a transmission request for the playback interruption information is received from another content playback apparatus, and
a playback controller that acquires the corresponding content in accordance with the playback interruption information and that causes the playback unit to play back the acquired content when the playback interruption information transmitted in response to the transmission request by the transmission request unit is received, and
wherein the portable terminal includes
a terminal identification information transmission unit that transmits the terminal identification information of the portable terminal to a first content playback apparatus that detects the portable terminal by the detection unit, and
a playback request unit that transmits the terminal identification information of the portable terminal to a second content playback apparatus and that requests the second content playback apparatus to play back the corresponding content when the portable terminal is detected by the detection unit of the second content playback apparatus after the terminal identification information transmission unit transmits the terminal identification information.

16. A content playback apparatus comprising:
a playback unit that plays back content provided from a content server;
a detection unit that detects a portable terminal in accordance with a short-distance communication method;
a transmission unit that transmits to the portable terminal detected by the detection unit playback interruption information including content identification information for identifying the content when playback of the content by the playback unit is interrupted; and
a provision request unit that receives the playback interruption information from the portable terminal detected by the detection unit and that requests the content server to provide the corresponding content in accordance with the playback interruption information.

17. A content playback apparatus comprising:
a playback unit that plays back content;
a detection unit that detects a portable terminal in accordance with a short-distance communication method;
a storing unit that receives from the portable terminal detected by the detection unit terminal identification information for identifying the portable terminal and that stores, in association with the received terminal identification information, playback interruption information including content identification information for identifying content whose playback is interrupted when playback of the content by the playback unit is interrupted;
a transmission request unit that multicasts the terminal identification information to other content playback apparatuses and that requests transmission of playback interruption information corresponding to the terminal identification information when the terminal identification information of the portable terminal and a playback request for the content are received from the portable terminal detected by the detection unit;
a playback interruption information transmission unit that reads the playback interruption information corresponding to the received terminal identification information from the storing unit and that transmits the read playback interruption information when a transmission request for the playback interruption information is received from another content playback apparatus; and
a playback controller that acquires the corresponding content in accordance with the playback interruption information and that causes the playback unit to play back the acquired content when the playback interruption information transmitted in response to the transmission request by the transmission request unit is received.
